(19) United States
(12) Patent Application Publication
(10) Pub. No.: US 2024/0150629 A1
(43) Pub. Date: May 9, 2024

(54) ACTINIC RAY-CROSSLINKABLE ADHESIVE AGENT COMPOSITION, CROSS-LINKED ADHESIVE AGENT, ADHESIVE SHEET, AND METHODS FOR MANUFACTURING SAME

(71) Applicant: LINTEC CORPORATION, Tokyo (JP)

(72) Inventor: Kenta NISHIJIMA, Kawaguchi-shi, Saitama (JP)

(73) Assignee: LINTEC CORPORATION, Tokyo (JP)

(21) Appl. No.: 18/284,331

(22) PCT Filed: Mar. 28, 2022
(86) PCT No.: PCT/JP2022/014768

§ 371 Date: Sep. 27, 2023

(30) Foreign Application Priority Data
Mar. 30, 2021 (JP) 2021-057698

(51) Int. Cl. C09J 153/02; C09J 7/38

(52) U.S. Cl. CPC C09J 153/02; C09J 7/387

(57) ABSTRACT

Provided are an energy ray-crosslinkable pressure sensitive adhesive composition, a pressure sensitive adhesive sheet containing the composition, a crosslinked pressure sensitive adhesive obtained by crosslinking the composition using an energy ray, a method for producing the crosslinked pressure sensitive adhesive, a pressure sensitive adhesive sheet containing the crosslinked pressure sensitive adhesive, and a method for producing the pressure sensitive adhesive sheet. The energy ray-crosslinkable pressure sensitive adhesive composition contains: (A) a block copolymer of an aromatic vinyl compound and a diene compound, the block copolymer containing a vinyl group in a side chain; (B) a tackifier having a softening point of 80° C. or higher and 150° C. or lower; and (C) a photopolymerization initiator.

### TECHNICAL FIELD

The present invention relates to an energy ray-crosslinkable pressure sensitive adhesive composition, a crosslinked pressure sensitive adhesive, pressure sensitive adhesive sheet, and methods for producing these.

### BACKGROUND ART

Pressure sensitive adhesive sheets have been used in a wide variety of industrial fields, such as for fixation or temporary fixation of a component in fields such as office-automation equipment, a home electrical appliance, an automobile, or building, for label to display various information, and for masking. Furthermore, a pressure sensitive adhesive sheet is also used as, for example, an optical clear adhesive (OCA) that fills an air gap between components to improve visibility in a display, a touch panel, or the like, which has been spread rapidly in recent years, and the use of the pressure sensitive adhesive sheet is further expanding.

Synthetic rubber-based pressure sensitive adhesives have been widely used because a wide variety of pressure sensitive adhesion performances can be designed by molecular design and by a combination with an additive, such as a tackifier, and also because of its relatively low cost. Furthermore, since the synthetic rubber-based pressure sensitive adhesive can be also used as a hot melt pressure sensitive adhesive that does not require a solvent at the time of coating onto a base material or the like, the synthetic rubber-based pressure sensitive adhesive is advantageous in that the environmental load of the production of the pressure sensitive adhesive sheet is small.

As the base resin of the synthetic rubber-based pressure sensitive adhesive, a block copolymer such as a styrene-isoprene-styrene (SIS) block copolymer is used. In the SIS, a soft segment made of a polyisoprene block contributes to adhesive strength, and at around room temperature, a hard segment made of a polystyrene block forms a physical pseudo crosslinking site by an intermolecular force, and thus adequate strength can be exhibited. Meanwhile, the pseudo crosslinking site has a property that it is uncoupled in a high temperature environment, and thus a cohesive strength of a pressure sensitive adhesive using an SIS is significantly decreased due to heating, and the pressure sensitive adhesive melts when a certain temperature is exceeded. This melting property can be advantageous in terms of enabling use as a hot melt pressure sensitive adhesive; however, this can be a cause of decrease in heat resistance of a pressure sensitive adhesive.

As the synthetic rubber-based pressure sensitive adhesive, Patent Document 1 describes a synthetic rubber-based pressure sensitive adhesive containing a synthetic rubber (A), an adhesion-imparting resin (B), and a fatty acid ester (C), in which the synthetic rubber (A) contains a styrene-isoprene block copolymer, a weight reduction rate of the fatty acid ester (C) after being heated at 150° C. for 10 minutes is 1 wt. % or less, and based on 100 parts by weight of the synthetic rubber (A), a content of the adhesion-imparting resin (B) is from 5 to 60 parts by weight, and a content of the fatty acid ester (C) is from 0.1 to 10 parts by weight.

### CITATION LIST

### Patent Literature

Patent Document 1: JP 2018-199810 A

### SUMMARY OF INVENTION

### Technical Problem

According to the technique of Patent Document 1, it is found that a synthetic rubber-based pressure sensitive adhesive that has excellent heat resistance and adhesiveness to a base material and that can suppress displacement, peeling or the like in a holding power test even in a high temperature environment can be provided.

However, even with the technique of Patent Document 1, displacement occurred in a retention test in a high temperature environment, and there is room for improvement in heat resistance.

The present invention has been completed in light of the problems described above, and an object of the present invention is to provide an energy ray-crosslinkable pressure sensitive adhesive composition that can form a pressure sensitive adhesive having excellent heat resistance while good adhesive strength is achieved; a pressure sensitive adhesive sheet containing the energy ray-crosslinkable pressure sensitive adhesive composition; a crosslinked pressure sensitive adhesive obtained by crosslinking the energy ray-crosslinkable pressure sensitive adhesive composition using an energy ray, and a method for producing the same; and a pressure sensitive adhesive sheet containing the crosslinked pressure sensitive adhesive, and a method for producing the same.

### Solution to Problem

The inventor of the present invention found that the problems described above can be solved by using a block copolymer having a specific structure and also using a tackifier having a specific physical property and a photopolymerization initiator, and thus completed the present invention.

That is, the present invention relates to [1] to [17] below.
[1] An energy ray-crosslinkable pressure sensitive adhesive composition containing:
(A) a block copolymer of an aromatic vinyl compound and a diene compound, the block copolymer containing a vinyl group in a side chain;
(B) a tackifier having a softening point of 80° C. or higher and 150° C. or lower; and
(C) a photopolymerization initiator.
[2] The energy ray-crosslinkable pressure sensitive adhesive composition according to [1] above, where the vinyl group contained in the side chain of the component (A) is a 1,2-vinyl group.
[3] The energy ray-crosslinkable pressure sensitive adhesive composition according to [1] or [2] above, where the aromatic vinyl compound is a styrene-based compound.
[4] The energy ray-crosslinkable pressure sensitive adhesive composition according to any one of [1] to [3] above, where the diene compound is 1,3-butadiene.
[5] The energy ray-crosslinkable pressure sensitive adhesive composition according to any one of [1] to [4] above, where the component (B) is a resin containing an aromatic ring.
[6] The energy ray-crosslinkable pressure sensitive adhesive composition according to [5] above, where the resin containing an aromatic ring is a styrene-based resin.
[7] The energy ray-crosslinkable pressure sensitive adhesive composition according to any one of [1] to [6] above, where the component (B) has a number average molecular weight (Mn) of from 500 to 2000.
[8] The energy ray-crosslinkable pressure sensitive adhesive composition according to any one of [1] to [7] above, where a content of the component (B) is from 50 to 200 parts by mass per 100 parts by mass of the component (A).
[9] The energy ray-crosslinkable pressure sensitive adhesive composition according to any one of [1] to [8] above, further containing (D) a softener that is liquid at 23° C.
[10] The energy ray-crosslinkable pressure sensitive adhesive composition according to [9] above, where a content of the component (D) is from 10 to 150 parts by mass per 100 parts by mass of the component (A).
[11] The energy ray-crosslinkable pressure sensitive adhesive composition according to any one of [1] to [10] above, where the energy ray-crosslinkable pressure sensitive adhesive composition is used for an optical material.
[12] A pressure sensitive adhesive sheet comprising an energy ray-crosslinkable pressure sensitive adhesive composition layer containing the energy ray-crosslinkable pressure sensitive adhesive composition described in any one of [1] to [11] above on abase material or a release material.
[13] A crosslinked pressure sensitive adhesive obtained by irradiating the energy ray-crosslinkable pressure sensitive adhesive composition described in any one of [1] to [11] above with an energy ray.
[14] The crosslinked pressure sensitive adhesive according to [13] above, where the crosslinked pressure sensitive adhesive has a gel fraction of from 10 to 70 mass %.
[15] A method for producing the crosslinked pressure sensitive adhesive described in [13] or [14] above, the method comprising irradiating the energy ray-crosslinkable pressure sensitive adhesive composition with an energy ray.
[16] A pressure sensitive adhesive sheet comprising a pressure sensitive adhesive layer containing the crosslinked pressure sensitive adhesive described in [13] or [14] above on a base material or a release material.
[17] A method for producing the pressure sensitive adhesive sheet described in
[16] above,
the method comprising:
forming an energy ray-crosslinkable pressure sensitive adhesive composition layer containing the energy ray-crosslinkable pressure sensitive adhesive composition on the base material or the release material; and
irradiating the energy ray-crosslinkable pressure sensitive adhesive composition layer with an energy ray.

### Advantageous Effects of Invention

According to the present invention, an energy ray-crosslinkable pressure sensitive adhesive composition that can form a pressure sensitive adhesive having excellent heat resistance while good adhesive strength is achieved; a pressure sensitive adhesive sheet containing the energy ray-crosslinkable pressure sensitive adhesive composition; a crosslinked pressure sensitive adhesive obtained by crosslinking the energy ray-crosslinkable pressure sensitive adhesive composition using an energy ray, and a method for producing the same; and a pressure sensitive adhesive sheet containing the crosslinked pressure sensitive adhesive, and a method for producing the same are provided.

### BRIEF DESCRIPTION OF DRAWINGS

FIG. 1 is a schematic cross-sectional view illustrating an example of a configuration of a pressure sensitive adhesive sheet according to the present invention.

FIG. 2 is a schematic cross-sectional view illustrating another example of a configuration of a pressure sensitive adhesive sheet according to the present invention.

FIG. 3 is a schematic cross-sectional view illustrating another example of a configuration of a pressure sensitive adhesive sheet according to the present invention.

### DESCRIPTION OF EMBODIMENTS

In the present specification, an “active component” refers to a component excluding a diluent solvent from components contained in a target composition.

In addition, in the present specification, the number average molecular weight (Mn) and the mass average molecular weight (Mw) are values measured by gel permeation chromatography (GPC) method calibrated with polystyrene standards, and specifically are values measured based on the method described in Examples.

In the present specification, the lower and upper limits of a preferable numerical range (for example, a range of content) described in series can each be independently combined. For example, from the description “preferably from 10 to 90, more preferably from 30 to 60”, the “preferred lower limit (10)” and the “preferred upper limit (60)” can be combined as “from 10 to 60”.

In the present specification, the “energy ray” means an electromagnetic wave or a charged particle beam having an energy quantum, and examples include ultraviolet rays, radiation, and electron beams. The ultraviolet rays can be irradiated by using, for example, an electrodeless lamp, a high-pressure mercury lamp, a metal halide lamp, or a UV-LED as an ultraviolet ray source. The electron beam can be generated by an electron beam accelerator or the like and irradiated. Note that the energy ray in an embodiment of the present invention is preferably an ultraviolet ray among those described above.

In the present specification, “energy ray-crosslinkable” refers to a property of forming a crosslinked structure by irradiation with an energy ray.

The mechanism of action described in the present specification is a presumption and does not limit the mechanism exhibiting the effect of the present invention.

### Energy Ray-Crosslinkable Pressure Sensitive Adhesive Composition and Crosslinked Pressure Sensitive Adhesive

The energy ray-crosslinkable pressure sensitive adhesive composition of the present embodiment is an energy ray-crosslinkable pressure sensitive adhesive composition containing:
(A) a block copolymer of an aromatic vinyl compound and a diene compound, the block copolymer containing a vinyl group in a side chain;
(B) a tackifier having a softening point of 80° C. or higher and 150° C. or lower; and
(C) a photopolymerization initiator.

Furthermore, the crosslinked pressure sensitive adhesive of the present embodiment is a crosslinked pressure sensitive adhesive obtained by irradiating the energy ray-crosslinkable pressure sensitive adhesive composition of the present embodiment with an energy ray.

The crosslinked pressure sensitive adhesive obtained by irradiating the energy ray-crosslinkable pressure sensitive adhesive composition of the present embodiment with an energy ray has excellent heat resistance while good adhesive strength is achieved. The reason thereof is presumed as follows.

The energy ray-crosslinkable pressure sensitive adhesive composition of the present embodiment contains (A) a block copolymer of an aromatic vinyl compound and a diene compound, the block copolymer containing a vinyl group in a side chain.

In the block copolymer, the aromatic vinyl compound block forms a physical pseudo crosslinking site, similarly to a known SIS or the like, and in addition, the vinyl group in the side chain forms a chemical crosslinking site by irradiation with an energy ray in the presence of (C) a photopolymerization initiator. That is, it is conceived that, since the crosslinked pressure sensitive adhesive of the present embodiment has both the physical pseudo crosslinking site and the chemical crosslinking site, good cohesive strength is maintained even at high temperatures, and heat resistance is improved. Furthermore, the energy ray-crosslinkable pressure sensitive adhesive composition of the present embodiment contains, as the component (B), a tackifier having a softening point of 80° C. or higher and 150° C. or lower, and it is conceived that the tackifier has good miscibility with the component (A) and imparts high transparency and good adhesive strength to the crosslinked pressure sensitive adhesive.

Hereinafter, the energy ray-crosslinkable pressure sensitive adhesive composition of the present embodiment (hereinafter, also simply referred to as “pressure sensitive adhesive composition”) and the crosslinked pressure sensitive adhesive will be described in further detail.

Note that, in the following description, (A) the block copolymer of an aromatic vinyl compound and a diene compound, which contains a vinyl group in a side chain, may be simply referred to as “block copolymer (A)” or “component (A)”. (B) the tackifier having a softening point of 80° C. or higher and 150° C. or lower may be simply referred to as “tackifier (B)” or “component (B)”. “(C) the photopolymerization initiator” may be simply referred to as “component (C)”.

### Energy Ray-Crosslinkable Pressure Sensitive Adhesive Composition

The pressure sensitive adhesive composition of the present embodiment forms a crosslinked pressure sensitive adhesive having excellent heat resistance due to formation of a crosslinked structure caused by irradiation with an energy ray as described above. That is, the pressure sensitive adhesive composition of the present embodiment is a composition that is designed to be irradiated with an energy ray before or after adhering to an adherend.

The pressure sensitive adhesive composition of the present embodiment can be irradiated with the energy ray at freely chosen time. Thus, the pressure sensitive adhesive composition of the present embodiment has high flexibility in terms of the method of production and method of use thereof.

Specifically, because no intentional crosslinked structure is formed in the pressure sensitive adhesive composition of the present embodiment, the pressure sensitive adhesive composition can be heated and melted and is also suitable as a hot melt pressure sensitive adhesive.

Furthermore, because no intentional crosslinked structure is formed in the pressure sensitive adhesive composition of the present embodiment, the pressure sensitive adhesive composition has excellent ability to fit to recesses and protrusions. Therefore, the ability to fit to recesses and protrusions, holding power, and heat resistance can be achieved in a highly compatible manner when the pressure sensitive adhesive composition of the present embodiment is adhered to an adherend having a difference in height and then a crosslinked pressure sensitive adhesive is formed by energy ray irradiation.

Each component contained in the pressure sensitive adhesive composition of the present embodiment will be described in detail below.

### (A) Block Copolymer

The block copolymer (A) is a block copolymer of an aromatic vinyl compound and a diene compound and has a vinyl group in a side chain (hereinafter, also referred to as “side chain vinyl group”).

That is, the block copolymer (A) is a block copolymer containing a polymer block made of a constitutional unit derived from an aromatic vinyl compound (hereinafter, also referred to as “aromatic block”) and a polymer block made of a constitutional unit derived from a diene compound (hereinafter, also referred to as “diene block”).

One type of these block copolymers (A) may be used alone, or two or more types of these block copolymers (A) may be used in combination.

### Aromatic Block

Examples of the aromatic vinyl compound, which is a monomer of an aromatic block, include a styrene-based compound, such as styrene, α-methylstyrene, o-methylstyrene, m-methylstyrene, p-methylstyrene, p-t-butylstyrene, 1,3-dimethylstyrene, and 2,4-dimethylstyrene; 1-vinylnaphthalene, and vinylanthracene. Among these, from the viewpoints of heat resistance and versatility, a styrene-based compound is preferred.

The constitutional units derived from the aromatic vinyl compound contained in the aromatic block may be one type or two or more types.

The content of the constitutional unit derived from the styrene-based compound in the aromatic block is preferably from 50 to 100 mass %, more preferably from 70 to 100 mass %, and even more preferably from 90 to 100 mass %, with respect to the total amount (100 mass %) of the aromatic block.

The mass average molecular weight (Mw) per 1 block of the aromatic block is preferably from 5000 to 50000, more preferably from 7000 to 25000, and even more preferably from 9000 to 17000.

When the mass average molecular weight (Mw) per 1 block of the aromatic block is in the range described above, a crosslinked pressure sensitive adhesive having adhesive strength, holding power, and heat resistance in a well-balanced manner tends to be obtained.

The content of the aromatic block in the block copolymer (A) is preferably from 10 to 50 mass %, more preferably from 11 to 40 mass %, and even more preferably from 12 to 35 mass %, with respect to the total amount (100 mass %) of the block copolymer (A).

When the content of the aromatic block in the block copolymer (A) is in the range described above, a crosslinked pressure sensitive adhesive having adhesive strength, holding power, and heat resistance in a well-balanced manner tends to be obtained.

### Diene Block

Examples of the diene compound, which is a monomer of the diene block, include 1,3-butadiene, isoprene, chloroprene, 2,3-dimethylbutadiene, 1,3-pentadiene, and 1,3-hexadiene.

The constitutional units derived from the diene compound contained in the diene block may be one type or two or more types.

Note that the block copolymer (A) has a vinyl group in a side chain. The vinyl group is preferably a 1,2-vinyl group, and more preferably a 1,2-vinyl group contained in a side chain of the diene block. Thus, the diene compound constituting the diene block is preferably a compound that can provide a 1,2-vinyl group, and more preferably 1,3-butadiene.

The content of the constitutional unit derived from 1,3-butadiene in the diene block is preferably from 50 to 100 mass %, more preferably from 70 to 100 mass %, and even more preferably from 90 to 100 mass %, with respect to the total amount (100 mass %) of the diene block.

The mass average molecular weight (Mw) per 1 block of the diene block is preferably from 15000 to 250000, more preferably from 17000 to 150000, and even more preferably from 20000 to 100000.

When the mass average molecular weight (Mw) per 1 block of the diene block is in the range described above, a crosslinked pressure sensitive adhesive having adhesive strength, holding power, and heat resistance in a well-balanced manner tends to be obtained.

The content of the diene block in the block copolymer (A) is preferably from 50 to 90 mass %, more preferably from 60 to 89 mass %, and even more preferably from 65 to 88 mass %, with respect to the total amount (100 mass %) of the block copolymer (A).

When the content of the diene block in the block copolymer (A) is in the range described above, a crosslinked pressure sensitive adhesive having adhesive strength, holding power, and heat resistance in a well-balanced manner tends to be obtained.

The content of the constitutional unit having a side chain vinyl group in the diene block is preferably from 20 to 70 mol %, more preferably from 30 to 60 mol %, and even more preferably from 35 to 50 mol %, with respect to all the constitutional units (100 mol %) constituting the diene block.

When the content of the constitutional unit having a side chain vinyl group in the diene block is in the range described above, a crosslinked pressure sensitive adhesive having adhesive strength, holding power, and heat resistance in a well-balanced manner tends to be obtained.

### Molecular Structure of Block Copolymer (A)

The molecular structure of the block copolymer (A) may be a linear structure or a branched structure.

When the block copolymer (A) has a branched structure, the number of branching point may be one, or the structure may be a multibranched structure having two or more branching points.

When the block copolymer (A) has a branched structure, the block copolymer (A) may have a radial structure. Note that, in the present embodiment, the block copolymer (A) having a radial structure means a structure including an atom or molecule that serves as a core and more than two polymer chains extended from the core. The atom or molecule that serves as a core is also known as a branching point in the branched structure.

Among these molecular structures, from the viewpoint of high energy ray-crosslinkability, the block copolymer (A) preferably has a branched structure, and more preferably has a radial structure.

### Bonding Mode of Aromatic Block and Diene Block

The bonding mode of the aromatic block and the diene block in the block copolymer (A) is not particularly limited. When an aromatic block is expressed as A, and a diene block is expressed as B, examples of the bonding mode include an A-B diblock copolymer, an A-B-A triblock copolymer, and an A-B-A-B tetrablock copolymer.

Among these, since adequate strength can be exhibited by forming a large number of physical pseudo crosslinking sites in molecular terminals, the block copolymer (A) is preferably an A-B-A triblock copolymer.

The block copolymer (A) may contain another polymer block besides the aromatic block and the diene block in a range that does not impair the object of the present invention. Examples of the bonding mode in this case include, when the other polymer block is expressed as C, an A-B-C triblock copolymer, an A-B-C-A tetrablock copolymer, and an A-B-A-C tetrablock copolymer.

The block copolymer (A) may be a block copolymer (A) having two or more polymer chains having any of the bonding modes described above bonded to an atom or molecule that serves as a core. Examples of such a structure include a structure represented by Formula (1) below.

(A-B)ₚX(B)_{q} (1)

In the formula above, X represents a residue of a coupling agent having an m-valent active site, m represents an integer of 3 or greater, and p and q each represent a number. An average value of p is 1 or greater, an average value of q is 0 or greater, and a sum of p and q is 2 or greater and m or less.

Examples of the coupling agent that provides the residue X in Formula (1) above include tris(nonylphenyl) phosphite, tetrachlorosilane, tetramethoxysilane, diethyl adipate, dimethyl adipate, and γ-glycidoxypropyltrimethoxysilane.

In Formula (1) above, m is preferably an integer of 3 to 6.

In Formula (1) above, an average value of p is preferably from 1.5 to (m−0.5), and an average value of q is preferably from 0.5 to (m−1.5). Furthermore, a sum of p and q is preferably 2 or greater and less than m. The sum of p and q may be, for example, greater than 2, 2.5 or greater, or 3 or greater. Note that, for example, a case where p is 1.5 in the structure described above means a mixture of a block copolymer having the p of 2 and a block copolymer having the p of 1.

Note that, in the description above related to the bonding mode, in a case where two or more aromatic blocks, two or more diene blocks, or two or more other polymer blocks are contained in a molecule, the two or more aromatic blocks, two or more diene blocks, or two or more other polymer blocks C may be the same or different.

The mass average molecular weight (Mw) of the block copolymer (A) is preferably from 50000 to 500000, more preferably from 100000 to 400000, and even more preferably from 150000 to 350000.

When the mass average molecular weight (Mw) of the block copolymer (A) is in the range described above, a crosslinked pressure sensitive adhesive having adhesive strength and heat resistance in a well-balanced manner tends to be obtained.

The number average molecular weight (Mn) of the block copolymer (A) is preferably from 20000 to 470000, more preferably from 70000 to 370000, and even more preferably from 130000 to 320000.

When the number average molecular weight (Mn) of the block copolymer (A) is in the range described above, a crosslinked pressure sensitive adhesive having adhesive strength and heat resistance in a well-balanced manner tends to be obtained.

The melt flow rate of the block copolymer (A) is preferably from 1 to 15 g/10 min, more preferably from 2 to 10 g/10 min, and even more preferably from 3 to 7 g/10 min.

When the melt flow rate of the block copolymer (A) is 1 g/10 min or greater, good hot melt coatability tends to be achieved. Furthermore, when the melt flow rate of the block copolymer (A) is 15 g/10 min or less, holding power at high temperatures of the pressure sensitive adhesive composition tends to be improved.

Note that, in the present specification, the melt flow rate of the block copolymer (A) means a value measured at a temperature of 200° C. and a load of 5 kg in accordance with JIS K 7210:1999.

Specific examples of the block copolymer (A) include a block copolymer that has a vinyl group in a side chain and contains a styrene block as the aromatic block and an isoprene block as the diene block, such as a styrene-isoprene-styrene block copolymer (SIS); a block copolymer that has a vinyl group in a side chain and contains a styrene block as the aromatic block and a butadiene block as the diene block, such as a styrene-butadiene-styrene block copolymer (SBS) and a styrene-butadiene-styrene-butadiene block copolymer (SBSB); and a block copolymer obtained by hydrogenating a part of these block copolymers. Among these, a styrene-butadiene-styrene block copolymer (SBS) is preferred.

The content of the block copolymer (A) in the pressure sensitive adhesive composition of the present embodiment is preferably from 10 to 70 mass %, more preferably from 20 to 60 mass %, and even more preferably from 25 to 50 mass %, with respect to the total amount (100 mass %) of the pressure sensitive adhesive composition.

When the content of the block copolymer (A) is 10 mass % or greater, good cohesive strength of the resulting crosslinked pressure sensitive adhesive is achieved, and even better heat resistance tends to be achieved. Furthermore, when the content of the block copolymer (A) is 70 mass % or less, adhesive strength to an adherend is improved and melt viscosity is not excessively high, and even better hot melt coatability tends to be achieved.

### (B) Tackifier Having Softening Point of 80° C. or Higher and 150° C. or Lower

The tackifier (B) is not particularly limited as long as the tackifier (B) is a tackifier having a softening point of 80° C. or higher and 150° C. or lower.

One type of the tackifier (B) may be used alone, or two or more types of the tackifiers (B) may be used in combination.

Examples of the tackifier (B) include a rosin-based resin such as polymerized rosin, a polymerized rosin ester, and a rosin derivative; a terpene-based resin such as a polyterpene resin, an aromatic-modified terpene resin and a hydrogenated product thereof, and a terpene phenol resin; a coumarone-indene resin; a petroleum resin such as an aliphatic petroleum resin, an aromatic petroleum resin and a hydrogenated product thereof, and an aliphatic/aromatic copolymer petroleum resin; a styrene or substituted styrene polymer; and a styrene-based resin such as an α-methylstyrene homopolymer resin, a copolymer of α-methylstyrene and styrene, a copolymer of a styrene-based monomer and an aliphatic hydrocarbon-based monomer; a copolymer of styrene, an α-methylstyrene, and an aliphatic hydrocarbon-based monomer, a homopolymer of a styrene-based monomer, and a copolymer of a styrene-based monomer and an aromatic monomer.

Among these, from the viewpoints of achieving excellent transparency of the resulting crosslinked pressure sensitive adhesive and suitability for use in an optical material and from the viewpoint of achieving even better heat resistance of the crosslinked pressure sensitive adhesive, the tackifier (B) is preferably a resin containing an aromatic ring, more preferably a styrene-based resin, and even more preferably a copolymer of a styrene-based monomer and an aliphatic hydrocarbon-based monomer.

The softening point of the tackifier (B) contained in the pressure sensitive adhesive composition of the present embodiment is 80° C. or higher and 150° C. or lower.

When the softening point of the tackifier (B) is 80° C. or higher, excellent tackiness is achieved. Furthermore, when the softening point of the tackifier (B) is 150° C. or lower, excellent adhesive strength is achieved.

From the same viewpoint described above, the softening point of the tackifier (B) is preferably from 70 to 150° C., more preferably from 80 to 130° C., and even more preferably from 90 to 115° C.

Note that, in the present specification, the softening point of the tackifier (B) means a value measured in accordance with JIS K 2531.

When two or more types of tackifiers are used, a weighted average of the softening points of the plurality of the tackifiers is preferably in the range described above.

The number average molecular weight (Mn) of the tackifier (B) is preferably from 500 to 2000, more preferably from 600 to 1500, and even more preferably from 700 to 1130.

The number average molecular weight (Mn) of the tackifier (B) is 500 or greater, shape maintainability tends to be further improved. Furthermore, when the number average molecular weight (Mn) of the tackifier (B) is 2000 or less, even better adhesive strength tends to be achieved at around room temperature.

The mass average molecular weight (Mw) of the tackifier (B) is preferably from 700 to 2500, more preferably from 900 to 2000, and even more preferably from 1100 to 1700.

The mass average molecular weight (Mw) of the tackifier (B) is 700 or greater, shape maintainability tends to be further improved. Furthermore, when the mass average molecular weight (Mw) of the tackifier (B) is 2500 or less, even better adhesive strength tends to be achieved at around room temperature.

The Hazen scale (APHA) of the tackifier (B) is preferably 200 or less, more preferably 160 or less, and even more preferably 140 or less.

When the Hazen scale of the tackifier (B) is in the range described above, the resulting crosslinked pressure sensitive adhesive tends to have excellent transparency and tends to be suitable for use in an optical material.

The lower limit value of the Hazen scale of the tackifier (B) is not particularly limited; however, from the viewpoint of ease in production, the Hazen scale may be 1 or greater, or 10 or greater.

The Hazen scale in the present embodiment can be measured in accordance with JIS K 0071-1:2017.

The content of the tackifier (B) in the pressure sensitive adhesive composition of the present embodiment is preferably from 50 to 200 parts by mass, more preferably from 60 to 180 parts by mass, and even more preferably from 80 to 160 parts by mass, with respect to 100 parts by mass of the block copolymer (A).

When the content of the tackifier (B) is in the range described above, even better adhesive strength tends to be achieved.

### (C) Photopolymerization Initiator

The pressure sensitive adhesive composition of the present embodiment further contains a photopolymerization initiator (C).

When the pressure sensitive adhesive composition of the present embodiment contains the photopolymerization initiator (C), even with an energy ray having a relatively low energy, such as an ultraviolet ray, the reaction of the side chain vinyl group contained in the block copolymer (A) adequately proceeds, and crosslinking of the pressure sensitive adhesive composition is promoted.

One type of the photopolymerization initiator (C) may be used alone, or two or more types of the photopolymerization initiators (C) may be used in combination.

Examples of the photopolymerization initiator (C) include 1-hydroxycyclohexyl phenyl ketone, benzoin, benzoin methyl ether, benzoin ethyl ether, benzoin propyl ether, benzyl phenyl sulfide, tetramethylthiuram monosulfide, azobisisobutyronitrile, dibenzyl, diacetyl, β-chloroanthraquinone, and bis(2,4,6-trimethylbenzoyl)phenylphosphine oxide. Among these, bis(2,4,6-trimethylbenzoyl)phenylphosphine oxide is preferred.

The content of the photopolymerization initiator (C) in the pressure sensitive adhesive composition of the present embodiment is preferably from 0.01 to 10 parts by mass, more preferably from 0.03 to 8 parts by mass, and even more preferably from 0.05 to 5 parts by mass, with respect to 100 parts by mass of the block copolymer (A).

When the content of the photopolymerization initiator (C) is 0.01 parts by mass or greater, an energy ray crosslinking reaction tends to be adequately proceeded.

Furthermore, when the content of the photopolymerization initiator (C) is 10 parts by mass or less, an energy ray crosslinking reaction tends to be uniformly proceeded.

(D) Softener that is Liquid at 23° C.

The pressure sensitive adhesive composition of the present embodiment preferably further contains (D) a softener that is liquid at 23° C. (hereinafter, also referred to as “softener (D)” or “component (D)”.

One type of the softener (D) may be used alone, or two or more types of the softeners (D) may be used in combination.

The softener (D) is liquid at 23° C. Note that, in the present specification, being liquid at 23° C. means that a pour point is 23° C. or lower.

The pour point of the softener (D) is preferably from −60 to 0° C., more preferably from −50 to −10° C., and even more preferably from −40 to −20° C.

When the pour point of the softener (D) is −60° C. or higher, heat resistance of the resulting crosslinked pressure sensitive adhesive tends to be even better. Furthermore, when the pour point of the softener (D) is 0° C. or lower, wettability and adhesive strength to an adherend tend to be even better.

The pour point of the softener (D) means a value measured in accordance with JIS K 2269:1987.

The softener (D) is not particularly limited, and a known softener can be used, and examples thereof include petroleum-based process oil such as paraffinic process oil, naphthenic process oil, and aromatic process oil; natural oil such as castor oil and tall oil; dialkyl dibasic acid such as dibutyl phthalate, dioctyl phthalate, and dibutyl adipate; and a low molecular weight liquid polymer such as liquid polybutene and liquid polyisoprene. Among these, naphthenic process oil is preferred.

The kinetic viscosity at 40° C. of the softener (D) is preferably from 50 to 150 mm²/s, more preferably from 70 to 120 mm²/s, and even more preferably from 80 to 100 mm²/s.

When the kinetic viscosity at 40° C. of the softener (D) is 50 mm²/s or greater, the pressure sensitive adhesive sheet tends to be adequately softened without deterioration of heat resistance. Furthermore, when the kinetic viscosity at 40° C. of the softener (D) is 150 mm²/s or lower, wettability and adhesive strength to an adherend tend to be even better.

The kinetic viscosity at 40° C. of the softener (D) in the present embodiment can be measured in accordance with JIS K 2283:2000.

The kinetic viscosity at 100° C. of the softener (D) is preferably from 1 to 20 mm²/s, more preferably from 3 to 15 mm²/s, and even more preferably from 6 to 10 mm²/s.

When the kinetic viscosity at 100° C. of the softener (D) is 1 mm²/s or greater, heat resistance of the resulting crosslinked pressure sensitive adhesive tends to be even better. Furthermore, when the kinetic viscosity at 100° C. of the softener (D) is 20 mm²/s or less, wettability and adhesive strength to an adherend tend to be even better.

The kinetic viscosity at 100° C. of the softener (D) in the present embodiment can be measured in accordance with JIS K 2283:2000.

When the pressure sensitive adhesive composition of the present embodiment contains the softener (D), the content of the softener (D) is preferably from 10 to 150 parts by mass, more preferably from 20 to 120 parts by mass, and even more preferably from 30 to 100 parts by mass, with respect to 100 parts by mass of the block copolymer (A).

When the content of the softener (D) is 10 parts by mass or greater, hot melt coatability and adhesive strength at around room temperature tend to be even better. Furthermore, when the content of the softener (D) is 150 parts by mass or less, heat resistance such as holding power at high temperatures tends to be even better.

### (E) Antioxidant

The pressure sensitive adhesive composition of the present embodiment preferably further contains (E) an antioxidant (hereinafter, also referred to as “component (E)”).

One type of the antioxidant (E) may be used alone, or two or more types of the antioxidants (E) may be used in combination.

The antioxidant (E) is not particularly limited and a known antioxidant can be used. Examples of the antioxidant (E) include a hindered phenol-based antioxidant such as 2,6-di-tert-butyl-4-(4,6-bis(octylthio)-1,3,5-triazin-2-ylamino)phenol, 2,6-di-t-butyl-4-methylphenol, n-octadecyl-3-(4′-hydroxy-3′,5′-di-t-butylphenyl) propionate, 2,2′-methylene bis(4-methyl-6-t-butylphenol), 2,2′-methylene bis(4-ethyl-6-t-butylphenol), 2,4-bis(octylthiomethyl)-o-cresol, 2-t-butyl-6-(3-t-butyl-2-hydroxy-5-methylbenzyl)-4-methylphenyl acrylate, 2,4-di-t-amyl-6-[1-(3,5-di-t-amyl-2-hydroxyphenyl)ethyl]phenyl acrylate, 2-[1-(2-hydroxy-3,5-di-tert-pentylphenyl)] acrylate, tetrakis[methylene-3-(3,5-di-t-butyl-4-hydroxyphenyl)propionate] methane; a sulfur-based antioxidant such as dilauryl thiodipropionate, lauryl stearyl thiodipropionate, and pentaerythritol tetrakis(3-laurylthiopropionate); and a phosphorus-based antioxidant such as tris(nonylphenyl) phosphite, and tris(2,4-di-t-butylphenyl) phosphite. Of these, a hindered phenol-based antioxidant and a phosphorus-based antioxidant are preferred.

When the pressure sensitive adhesive composition of the present embodiment contains the antioxidant (E), the content of the antioxidant (E) is preferably from 0.1 to 10 mass %, more preferably from 0.5 to 7 mass %, and even more preferably from 1 to 5 mass %, with respect to the total amount (100 mass %) of the pressure sensitive adhesive composition.

The content of the antioxidant (E) is 0.1 mass % or greater, excellent antioxidant effect tends to be achieved. Furthermore, when the content of the antioxidant (E) is 10 mass % or less, progression of an energy ray crosslinking reaction is less likely to be impaired, and even better heat resistance tends to be achieved.

### <Other Components>

The pressure sensitive adhesive composition of the present embodiment may or may not contain an additive for a pressure sensitive adhesive used in a typical pressure sensitive adhesive, in a range that does not impair the effect of the present invention.

Examples of such an additive for a pressure sensitive adhesive include a rubber polymer other than the component (A), a wax, a silane coupling agent, a filler, an extender, a heat stabilizer, a light stabilizer, a UV absorber, a colorant (e.g., pigment and dye), a flame retardant, an antistatic agent, a stringiness suppressing agent, a leveling agent, a crosslinking agent, a crosslinking aid, an antioxidant, an inorganic particle, an organic particle, and a weight reduction agent.

For each of these additives for pressure sensitive adhesives, the additive may be used alone, or two or more types of additives may be used in combination.

When these additives for pressure sensitive adhesives are contained, the content of each additive for a pressure sensitive adhesive is independently preferably from 0.0001 to 20 parts by mass, and more preferably from 0.001 to 10 parts by mass, relative to 100 parts by mass of the block copolymer (A).

The total amount of the components (A) to (E) in the pressure sensitive adhesive composition of the present embodiment is preferably from 80 to 100 mass %, more preferably from 90 to 100 mass %, and even more preferably from 95 to 100 mass %, with respect to the total amount (100 mass %) of the pressure sensitive adhesive composition.

The adhesive strength to SUS304 at 23° C. of the pressure sensitive adhesive composition of the present embodiment is preferably 1 N/25 mm or greater, more preferably 5 N/25 mm or greater, and even more preferably 10 N/25 mm or greater.

When the adhesive strength of the pressure sensitive adhesive composition is 1 N/25 mm or greater, displacement, peeling, and the like from an adherend are less likely to occur.

The upper limit value of the adhesive strength of the pressure sensitive adhesive composition is not particularly limited, and from the viewpoint of maintaining ease in production and other performances in a well-balanced manner, the upper limit value may be 70 N/25 mm or less, or 50 N/25 mm or less.

The adhesive strength to SUS304 at 23° C. of the pressure sensitive adhesive composition can be measured by the method described in Examples.

Since the pressure sensitive adhesive composition of the present embodiment is a composition prior to energy ray irradiation and no intentional crosslinked structure is formed, typically, a gel fraction thereof is low. From the viewpoints of hot melt coatability, ability to fit to recesses and protrusions, and adhesive strength, the gel fraction is preferably less than 15 mass %, more preferably 12 mass % or less, and even more preferably 10 mass % or less.

The lower limit value of the gel fraction of the pressure sensitive adhesive composition is not particularly limited, and from the viewpoint of ease in production, the lower limit value may be 0.1 mass % or greater, or 1 mass % or greater.

In the present embodiment, the gel fraction of the pressure sensitive adhesive composition can be measured by the method described in Examples.

### <Method for Producing Pressure Sensitive Adhesive Composition>

Examples of the method for producing the pressure sensitive adhesive composition of the present embodiment include a method in which the block copolymer (A), the tackifier (B), the photopolymerization initiator (C), and an optional component that is used as necessary are melt-kneaded (hereinafter, also referred to as “melt kneading method”); and a method in which the components described above are mixed in a solvent (hereinafter, also referred to as “solvent mixing method”).

For example, the melt kneading method is a method in which the components are charged in a mixing device equipped with a heating device, such as a heating kneader, and mixed in a state in which the components are melted. Examples of the mixing device equipped with a heating device include a single-screw extruder, a twin-screw extruder, a rolling mill, a Plastomill, a Banbury mixer, an intermix, and a pressure kneader. In a case where a mixing device that can reduce pressure is used, as necessary, the pressure in the inside of the mixing device may be reduced, and the melt-kneading may be performed under reduced pressure.

The kneading temperature in the melt kneading method is not particularly limited, and a temperature condition under which the components are adequately mixed in a melted state may be appropriately selected. The kneading temperature is preferably from 100 to 250° C., and more preferably from 120 to 220° C.

Note that, in a case where the pressure sensitive adhesive composition of the present embodiment is produced by a melt kneading method, the pressure sensitive adhesive composition of the present embodiment does not need to contain a solvent. From the viewpoint of reducing environmental load, no solvent is preferably contained.

The pressure sensitive adhesive composition obtained after completion of the melt kneading may be extruded in a heated and melted state as is onto a base material or a release material by an extruder or the like or may be supplied for production of a pressure sensitive adhesive sheet of the present embodiment described below, or as desired, may be charged in various containers or the like without undergoing molding process.

The solvent mixing method is, for example, a method of mixing the components in a state in which the components are dissolved and dispersed in a solvent.

Examples of the solvent include methyl ethyl ketone, acetone, ethyl acetate, tetrahydrofuran, dioxane, cyclohexane, n-hexane, toluene, xylene, n-propanol, and isopropanol. Among these, toluene is preferred. One type of the solvent may be used alone, or two or more types of the solvents may be used in combination.

The pressure sensitive adhesive composition obtained by mixing in the solvent may be then applied onto a base material, dried, and supplied for production of a pressure sensitive adhesive sheet of the present embodiment described below or, as desired, may be charged in various containers or the like without undergoing the coating process.

### Crosslinked Pressure Sensitive Adhesive

The crosslinked pressure sensitive adhesive of the present embodiment is a crosslinked pressure sensitive adhesive obtained by irradiating the energy ray-crosslinkable pressure sensitive adhesive composition of the present embodiment with an energy ray.

That is, the crosslinked pressure sensitive adhesive of the present embodiment has a crosslinked structure formed by a reaction of the side chain vinyl group of the block copolymer (A) contained in the energy ray-crosslinkable pressure sensitive adhesive composition of the present embodiment.

In the present embodiment, the crosslinked pressure sensitive adhesive itself also has good adhesive strength and exhibits excellent adhesive strength to an adherend. Thus, from the viewpoint of making an energy ray irradiation process after adhesion to an adherend unnecessary, an embodiment in which a crosslinked pressure sensitive adhesive of the present embodiment is formed by irradiation of the pressure sensitive adhesive composition with an energy ray prior to adhesion to an adherend, and the crosslinked pressure sensitive adhesive is adhered to the adherend as a crosslinked pressure sensitive adhesive is also preferred.

The adhesive strength to SUS304 at 23° C. of the crosslinked pressure sensitive adhesive of the present embodiment is preferably 1 N/25 mm or greater, more preferably 5 N/25 mm or greater, and even more preferably 10 N/25 mm or greater.

When the adhesive strength of the crosslinked pressure sensitive adhesive is 1 N/25 mm or greater, displacement, peeling, and the like from an adherend are less likely to occur.

The upper limit value of the adhesive strength of the crosslinked pressure sensitive adhesive is not particularly limited, and from the viewpoint of maintaining ease in production and other performances in a well-balanced manner, the upper limit value may be 70 N/25 mm or less, or 50 N/25 mm or less.

The adhesive strength to SUS304 at 23° C. of the crosslinked pressure sensitive adhesive can be measured by the method described in Examples.

The gel fraction of the crosslinked pressure sensitive adhesive of the present embodiment is preferably from 10 to 70 mass %, more preferably from 15 to 65 mass %, and even more preferably from 20 to 60 mass %.

When the gel fraction of the crosslinked pressure sensitive adhesive is 10 mass % or greater, even better heat resistance tends to be achieved. Furthermore, when the gel fraction of the crosslinked pressure sensitive adhesive is 70 mass % or less, even better adhesive strength tends to be achieved.

In the present embodiment, the gel fraction of the crosslinked pressure sensitive adhesive can be measured by the method described in Examples.

The crosslinked pressure sensitive adhesive of the present embodiment can be produced by a method including irradiating the energy ray-crosslinkable pressure sensitive adhesive composition of the present embodiment with an energy ray (hereinafter, also referred to as “energy ray irradiation process”).

In a case where an ultraviolet ray is used in the energy ray irradiation process, irradiance of the ultraviolet ray is preferably from 50 to 400 mW/cm², more preferably from 100 to 300 mW/cm², and even more preferably from 150 to 250 mW/cm².

In a case where an ultraviolet ray is used in the energy ray irradiation process, UV dose is preferably from 100 to 2000 mJ/cm², more preferably from 400 to 1500 mJ/cm², and even more preferably from 600 to 1000 mJ/cm².

However, the irradiation conditions of the energy ray is not limited to the range described above, and may be appropriately adjusted to a range that can provide a desired performance based on the types and used amounts of the block copolymer (A), the photopolymerization initiator (C), and the like.

### [Pressure Sensitive Adhesive Sheet]

The present invention provides a pressure sensitive adhesive sheet of a first embodiment and a pressure sensitive adhesive sheet of a second embodiment described below.

The pressure sensitive adhesive sheet of a first embodiment is a pressure sensitive adhesive sheet including an energy ray-crosslinkable pressure sensitive adhesive composition layer made of the energy ray-crosslinkable pressure sensitive adhesive composition of the present embodiment on a base material or a release material.

The pressure sensitive adhesive sheet of a second embodiment is a pressure sensitive adhesive sheet including a pressure sensitive adhesive layer made of the crosslinked pressure sensitive adhesive of the present embodiment (hereinafter, also simply referred to as “pressure sensitive adhesive layer”) on a base material or a release material.

In the description below, the “pressure sensitive adhesive sheet” simply mentioned means both the pressure sensitive adhesive sheet of the first embodiment and the pressure sensitive adhesive sheet of the second embodiment.

An example of the configuration of the pressure sensitive adhesive sheet of the present embodiment is described using drawings, but as long as the effects of the present embodiment are exhibited, the pressure sensitive adhesive sheet of the present embodiment is not limited to the following example.

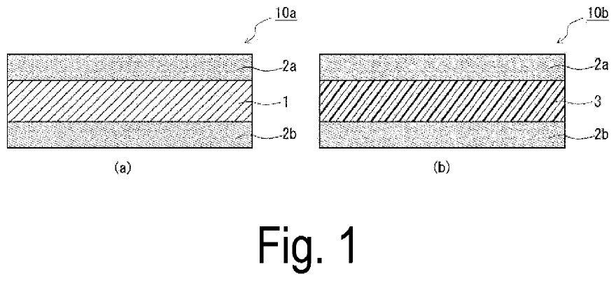

FIG. 1(a) illustrates a pressure sensitive adhesive sheet 10a without a base material as an example of a pressure sensitive adhesive sheet of a first embodiment, the pressure sensitive adhesive sheet 10a including release materials 2a and 2b on both sides of a pressure sensitive adhesive composition layer 1. FIG. 1(b) illustrates a pressure sensitive adhesive sheet 10b without a base material as an example of a pressure sensitive adhesive sheet of a second embodiment, the pressure sensitive adhesive sheet 10b including release materials 2a and 2b on both sides of a pressure sensitive adhesive layer 3.

The pressure sensitive adhesive sheets 10a and 10b are suitable for adhering adherends as follows. For example, after the release material 2a on one face side is released and removed, an adherend is adhered to the exposed pressure sensitive adhesive composition layer 1 or pressure sensitive adhesive layer 3, then the release material 2a is released and removed, and then the exposed face of the pressure sensitive adhesive composition layer 1 or pressure sensitive adhesive layer 3 is adhered to another adherend. Examples of such use include use for an optical material by which an air gap in between components are filled to improve visibility.

In a case where the pressure sensitive adhesive sheet adhered to the adherend is the pressure sensitive adhesive sheet of the first embodiment, after adhesion to the adherend, the pressure sensitive adhesive composition layer is irradiated with an energy ray to form the pressure sensitive adhesive layer.

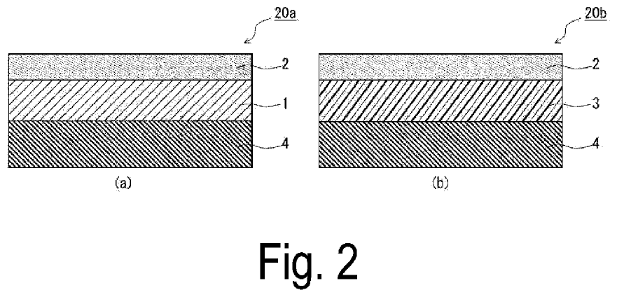

FIG. 2(a) illustrates a pressure sensitive adhesive sheet 20a including a release material 2 on one face side of the pressure sensitive adhesive composition layer 1 and a base material 4 on the other face side as another example of the pressure sensitive adhesive sheet of the first embodiment. FIG. 2(b) illustrates a pressure sensitive adhesive sheet 20b including a release material 2 on one face side of the pressure sensitive adhesive layer 3 and a base material 4 on the other face side as another example of the pressure sensitive adhesive sheet of the second embodiment.

The pressure sensitive adhesive sheets 20a and 20b are suitable for a method of use in which, a release material 2 is released and removed, and then the exposed face of the pressure sensitive adhesive composition layer 1 or pressure sensitive adhesive layer 3 is adhered to an adherend. Examples of such use include use for a label.

In a case where the pressure sensitive adhesive sheet adhered to the adherend is the pressure sensitive adhesive sheet of the first embodiment, after adhesion to the adherend, the pressure sensitive adhesive composition layer is irradiated with an energy ray to form the pressure sensitive adhesive layer.

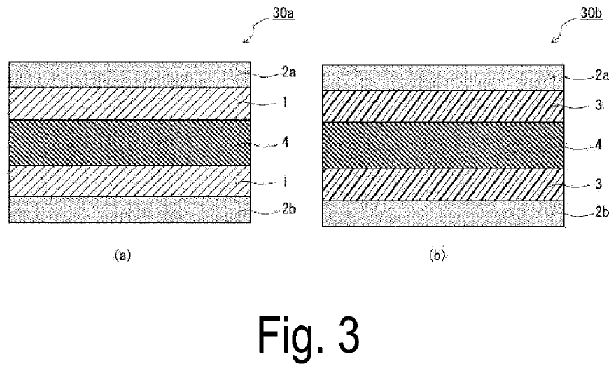

As another example of the pressure sensitive adhesive sheet of the first embodiment, FIG. 3(a) illustrates a double-sided pressure sensitive adhesive sheet 30a including: pressure sensitive adhesive composition layers 1 on both sides of a base material 4; a release material 2a on a face of one of the pressure sensitive adhesive composition layers 1, the face being opposite to the base material 4; and a release material 2b on a face of the other pressure sensitive adhesive composition layer 1, the face being opposite to the base material 4. As another example of the pressure sensitive adhesive sheet of the second embodiment, FIG. 3(b) illustrates a double-sided pressure sensitive adhesive sheet 30b including: pressure sensitive adhesive layers 3 on both sides of a base material 4; a release material 2a on a face of one of the pressure sensitive adhesive layers 3, the face being opposite to the base material 4; and a release material 2b on a face of the other pressure sensitive adhesive layer 3, the face being opposite to the base material 4.

Similarly to the pressure sensitive adhesive sheets 10a and 10b, the double-sided pressure sensitive adhesive sheets 30a and 30b are also suitable for adhering adherends and, in particular, is suitable for fixation or temporary fixation of various components.

The thickness of the pressure sensitive adhesive composition layer in the pressure sensitive adhesive sheet of the first embodiment and the thickness of the pressure sensitive adhesive layer in the pressure sensitive adhesive sheet of the second embodiment are each preferably from 5 to 100 μm, more preferably from 10 to 70 μm, and even more preferably from 15 to 40 μm.

When the thickness of the pressure sensitive adhesive composition layer or the pressure sensitive adhesive layer is 5 μm or greater, even better adhesive strength tends to be achieved. Furthermore, when the thickness of the pressure sensitive adhesive composition layer or the pressure sensitive adhesive layer is 100 μm or less, even better handleability tends to be achieved.

### Base Material

Examples of the base material include a resin, a metal, and a paper material.

Examples of the resin include a polyolefin resin such as polyethylene and polypropylene; a vinyl-based resin such as polyvinyl chloride, polyvinylidene chloride, polyvinyl alcohol, an ethylene-vinyl acetate copolymer, and an ethylene-vinyl alcohol copolymer; a polyester-based resin such as polyethylene terephthalate, polybutylene terephthalate, and polyethylene naphthalate; polystyrene; an acrylonitrile-butadiene-styrene copolymer; cellulose triacetate; polycarbonate; a urethane resin such as polyurethane and acrylic-modified polyurethane; polymethylpentene; polysulfone; polyether ether ketone; polyethersulfone; polyphenylene sulfide; a polyimide-based resin such as polyetherimide and polyimide; a polyamide-based resin; an acrylic resin; and a fluororesin.

Examples of the metal include aluminum, tin, chromium, and titanium.

Examples of the paper material include tissue paper, wood containing paper, wood-free paper, impregnated paper, coat paper, art paper, vegetable parchment, and glassine paper.

Among these, a polyester-based resin, such as polyethylene terephthalate, polybutylene terephthalate, and polyethylene naphthalate, is preferred.

These formation materials may include only one type or may be a combination of two or more types.

Examples of the base material in which two or more formation materials are used in combination include a material obtained by laminating a paper material with a thermoplastic resin such as polyethylene, and a material obtained by forming a metal film on a surface of a resin film or sheet containing a resin. Note that examples of a method of forming a metal layer include a method of subjecting the metal described above to vapor deposition by a PVD method, such as vacuum deposition, sputtering, or ion plating; or a method of adhering a metal foil made of the metal described above using a typical pressure sensitive adhesive.

Note that, from the viewpoint of improving interlayer adhesion of the base material and another layer to be laminated, in a case where the base material contains a resin, surface treatment by an oxidation method, a roughening method, or the like, adhesion improvement treatment, or primer treatment may be performed to a surface of the base material.

The base material may contain an additive for a base material as necessary. Examples of the additive for a base material include an ultraviolet absorber, a light stabilizer, an antioxidant, an antistatic agent, a slip agent, an antiblocking agent, and a colorant. These additives for base materials may each be used alone or in combination of two or more types.

The base material may include a primer layer to facilitate printing; a recording layer for enabling recording such as thermal transfer recording and ink jet recording; an overcoat film or an over-laminate film to protect these surfaces; and an information area such as magnetic recording, a bar code, and a micro-semiconductor element.

Furthermore, in a case where the pressure sensitive adhesive sheet of the present embodiment is used as a pressure sensitive adhesive sheet for an optical material, as the base material, a protective panel such as a glass plate and a plastic plate; a shatterproof film, a polarizing plate (polarizing film), a polarizer, a retardation plate (retardation film), a viewing-angle compensation film, a brightness improvement film, a contrast improvement film, a liquid-crystal polymer film, a diffusion film, a semitransmitting reflective film, and a transparent electroconductive film may be used.

The thickness of the base material is preferably from 5 to 500 μm, more preferably from 15 to 300 μm, and even more preferably from 20 to 200 μm.

When the thickness of the base material is 5 μm or greater, deformation resistance of the pressure sensitive adhesive sheet tends to be improved. On the other hand, when the thickness of the base material is 500 μm or less, handleability of the pressure sensitive adhesive sheet tends to be improved.

Note that the “thickness of the base material” means a thickness of the entire base material and, in a case where the base material contains a plurality of layers, means the total thickness of all the layers constituting the base material.

### Release Material

For the release material, a release sheet subjected to a double-sided release treatment, a release sheet subjected to a single-sided release treatment, or the like is used. Examples include a material prepared by applying a release agent onto a base material for release materials.

Examples of the base material for a release material include paper, such as woodfree paper, glassine paper, and kraft paper; and a plastic film, such as a polyester resin film of a polyethylene terephthalate resin, a polybutylene terephthalate resin, or a polyethylene naphthalate resin; and a polyolefin resin film of a polypropylene resin or a polyethylene resin.

Examples of the release agent include a rubber-based elastomer, such as a silicone-based resin, an olefin-based resin, an isoprene-based resin, and a butadiene-based resin; a long-chain alkyl-based resin; an alkyd-based resin; and a fluorine-based resin.

The thickness of the release material is not particularly limited as long as the thickness does not impair the effects of the present invention, and is preferably from 10 to 200 μm, more preferably from 20 to 180 μm, and even more preferably from 30 to 150 μm.

### Method for Producing Pressure Sensitive Adhesive Sheet of First Embodiment

The pressure sensitive adhesive sheet of the first embodiment can be produced by a method including forming a pressure sensitive adhesive composition layer on a base material or a release material (hereinafter, also referred to as “pressure sensitive adhesive composition layer formation process”). Note that, in the present embodiment, in a case where the release material is a release material having one face subjected to release treatment, “on a release material” means on the face subjected to release treatment.

In a case where the pressure sensitive adhesive composition of the present embodiment is produced by the melt kneading method described above, the pressure sensitive adhesive composition layer formation process may be a method in which a layer is formed by extruding the pressure sensitive adhesive composition, which is obtained after completion of the melt kneading, in a heated and melted state onto a base material or a release material by using an extruder and a T-die. Thereafter, as necessary, cooling of the pressure sensitive adhesive composition layer may be performed.

Furthermore, in a case where the pressure sensitive adhesive composition of the present embodiment is produced by the solvent mixing method described above, the pressure sensitive adhesive composition layer formation process may be a method in which the obtained solution is applied on a base material or a release material as the coating slip of the pressure sensitive adhesive composition and dried. Examples of the method of coating the coating slip of the pressure sensitive adhesive composition include a roll coating method, a spin coating method, a spray coating method, a bar coating method, a knife coating method, a roll knife coating method, a blade coating method, a die coating method, and a gravure coating method. The drying conditions after the coating may be adequately selected based on the type of the solvent.

By the pressure sensitive adhesive composition layer formation process, the pressure sensitive adhesive composition layer is formed on the base material or the release material. Thereafter, as necessary, a release material may be adhered to the exposed face of the pressure sensitive adhesive composition layer formed on the base material or the release material, or a process of adhering the pressure sensitive adhesive composition layer formed on the release material onto one or both faces of the base material may be performed.

### Method for Producing Pressure Sensitive Adhesive Sheet of Second Embodiment

The method for producing the pressure sensitive adhesive sheet of the second embodiment includes: forming an energy ray-crosslinkable pressure sensitive adhesive composition layer containing an energy ray-crosslinkable pressure sensitive adhesive composition on a base material or a release material; and irradiating the energy ray-crosslinkable pressure sensitive adhesive composition layer with an energy ray.

Forming an energy ray-crosslinkable pressure sensitive adhesive composition layer in the method for producing the pressure sensitive adhesive sheet of the second embodiment is the same as the pressure sensitive adhesive composition layer formation process in the method for producing the pressure sensitive adhesive sheet of the first embodiment.

The preferred conditions of the energy ray irradiation in a process of irradiating the energy ray-crosslinkable pressure sensitive adhesive composition layer with an energy ray in the method for producing of the pressure sensitive adhesive sheet of the second embodiment are the same as the conditions described in the energy ray irradiation process in the method for producing the crosslinked pressure sensitive adhesive.

In the method for producing the pressure sensitive adhesive sheet of the second embodiment, the timing at which the energy ray irradiation is performed is not particularly limited and may be appropriately selected taking into consideration the method for producing the pressure sensitive adhesive sheet, desired physical properties, and the like.

Specifically, for example, in a state in which the pressure sensitive adhesive composition layer is formed on a base material or a release material and a face on the other side of the pressure sensitive adhesive composition layer opposite to the base material or the release material is exposed, the pressure sensitive adhesive composition layer may be irradiated with the energy ray directly or through the base material or the release material.

Furthermore, in a state where one face of the pressure sensitive adhesive composition layer has a base material or a release material and the other face has a release material, the pressure sensitive adhesive composition layer may be irradiated with an energy ray through the base material or the release material.

Furthermore, the energy ray irradiation may be performed once or for a plurality of times. In a case where the energy ray irradiation is performed for a plurality of times, for example, a first energy ray irradiation may be performed in a state in which one face of the pressure sensitive adhesive composition layer is exposed, and then a second energy ray irradiation may be performed after a base material or a release material is adhered to the exposed face. Furthermore, a first energy ray irradiation may be performed at a timing before adhesion of an adherend, and the second energy ray irradiation may be performed after the adhesion of the adherend.

### Use of Energy Ray-Crosslinkable Pressure Sensitive Adhesive Composition, Crosslinked Pressure Sensitive Adhesive, and Pressure Sensitive Adhesive Sheet

The energy ray-crosslinkable pressure sensitive adhesive composition, crosslinked pressure sensitive adhesive, and pressure sensitive adhesive sheet of the present embodiment can be used for various uses.

Specific examples thereof include use for optical materials, use for labels, use for surface protection, use for masking, use for decoration and display, use for joints, use for sealants, use for medical care and hygiene, use for electrical insulation, use for holding and fixing electronic devices, and use for semiconductor production. Among these, use for optical materials or use for labels is preferred.

Examples of the use for optical materials include use for adhering one optical component and another optical component in a display body such as a liquid crystal (LCD) display, a light emitting diode (LED) display, an organic electroluminescence (organic EL) display, an electronic paper display, or a touch panel.

Examples of the optical component include a protective panel such as a glass plate and a plastic plate; a shatterproof film, a polarizing plate (polarizing film), a polarizer, a retardation plate (retardation film), a viewing-angle compensation film, a brightness improvement film, a contrast improvement film, a liquid-crystal polymer film, a diffusion film, a semitransmitting reflective film, and a transparent electroconductive film.

A pressure sensitive adhesive sheet for a label may be directly adhered to various products and may be adhered to a packaging film, a packaging container, or the like of various products. Examples of the constitutional material of the packaging film and the packaging container include an olefin-based resin such as polypropylene and polyethylene; a polyester-based resin such as polyethylene terephthalate (PET) and polylactic acid; glass, paper, and metal.

### EXAMPLES

The present invention will be specifically described with reference to examples below, but the present invention is not limited to the following examples. Physical property values in examples are values measured by the following methods.

### Number Average Molecular Weight (Mn) and Mass Average Molecular Weight (Mw)

Number Average Molecular Weight (Mn) and Mass Average Molecular Weight (Mw) were measured using a gel permeation chromatograph (product name “HLC-8020”, available from Tosoh Corporation) under the following conditions, and values measured in terms of standard polystyrene were used.

### Measurement Conditions

Column: “TSK guard column HXL-L”, “TSK gel G2500HXL”, “TSK gel G2000HXL”, and “TSK gel G1000HXL” (all available from Tosoh Corporation) connected in sequence
Column temperature: 40° C.
Developing solvent: tetrahydrofuran
Flow rate: 1.0 mL/min

### Thickness of Each Layer

The thickness of each layer was measured at 23° C. by using a constant pressure thickness meter (model number: “PG-02J”, standard specifications: in accordance with JIS K 6783, Z 1702, and Z 1709) available from Teclock Co., Ltd.

Details of the materials used in the following Examples and Comparative Example are shown below.

### Component (A)

SBS containing vinyl group in side chain: styrene-butadiene-styrene block copolymer (SBS) containing a 1,2-vinyl group in a side chain [copolymer having a branched structure and having a radial structure including a branching point as a core; number average molecular weight (Mn): 160000; mass average molecular weight (Mw): 180000; the content of the styrene block was 20 mass %; the content of the butadiene block was 80 mass %; the content of the constituent unit containing a 1,2-vinyl group in a side chain was 42 mol % in all constitutional units constituting the butadiene block; melt flow rate measured at a temperature of 200° C. and a load of 5 kg: 5 g/10 min].

### Comparative Component

SIS containing no vinyl group in side chain: styrene-isoprene-styrene block copolymer (SIS) having no vinyl group in a side chain [mass average molecular weight (Mw): 125000]

### Component (B)

Tackifier (B1): copolymer of a styrene-based monomer and an aliphatic hydrocarbon-based monomer [trade name “FTR 6100” available from Mitsui Chemicals Inc.; softening point: 95° C.; number average molecular weight (Mn): 900; mass average molecular weight (Mw): 1200; Hazen scale (APHA): 125]
Tackifier (B2): copolymer of a styrene-based monomer and an aliphatic hydrocarbon-based monomer [trade name “FTR 6110” available from Mitsui Chemicals Inc.; softening point: 110° C.; number average molecular weight (Mn): 1100; mass average molecular weight (Mw): 1600; Hazen scale (APHA): 125]
Tackifier (B3): copolymer of a styrene-based monomer and an aliphatic hydrocarbon-based monomer [trade name “FTR 6125” available from Mitsui Chemicals Inc.; softening point: 125° C.; number average molecular weight (Mn): 1200; mass average molecular weight (Mw): 2000; Hazen scale (APHA): 125]
Tackifier (B4): styrene-based resin [trade name “FTR 8100” available from Mitsui Chemicals Inc.; softening point: 100° C.; number average molecular weight (Mn): 800; mass average molecular weight (Mw): 1200; Hazen scale (APHA): 100]

### Component (C)

Photopolymerization initiator: bis(2,4,6-trimethylbenzoyl)phenylphosphine oxide

### Component (D)

Softener that is liquid at 23° C.: naphthene-based process oil [trade name “NYFLEX 223”, available from Nynas AB; kinetic viscosity at 40° C.: 88 mm²/s; kinetic viscosity at 100° C.: 8.4 mm²/s; pour point: −33° C.]

### Antioxidant (E)

A combination of a hindered phenol-based antioxidant and a phosphorus-based antioxidant in mass ratio of 1:1 was used.

### Examples 1 to 8 and Comparative Example 1

### Production of Pressure Sensitive Adhesive Sheet of First Embodiment

The components listed in Table 1 were dissolved in a toluene in a blended amount listed in Table 1, and thus an energy ray-crosslinkable pressure sensitive adhesive composition was prepared. Note that the formulation listed in Table 1 means the blended amount of the active component (unit: part by mass).

Then, this energy ray-crosslinkable pressure sensitive adhesive composition was applied onto a release-treated face of a tight release sheet (trade name “SP-PET382150”, available from LINTEC Corporation), the obtained coating was dried at 100° C. for 2 minutes, and thus an energy ray-crosslinkable pressure sensitive adhesive composition layer having a thickness of 25 μm was formed on the tight release sheet. On an exposed face of this energy ray-crosslinkable pressure sensitive adhesive composition layer, a release-treated face of an easy release sheet (trade name “SP-PET381130”, available from LINTEC Corporation) was adhered. Thus, a pressure sensitive adhesive sheet of the first embodiment having release sheets on both sides of an energy ray-crosslinkable pressure sensitive adhesive composition layer was prepared.

### Production of Pressure Sensitive Adhesive Sheet of Second Embodiment

The pressure sensitive adhesive sheet of the first embodiment obtained described above was irradiated with an ultraviolet ray at an irradiance of 200 mW/cm² and a dose of 800 mJ/cm² from the tight release sheet side by using a conveyor-type UV irradiation device (available from Heraeus; electrodeless UV lamp), a pressure sensitive adhesive layer obtained by crosslinking the energy ray-crosslinkable pressure sensitive adhesive composition layer contained in the pressure sensitive adhesive sheet of the first embodiment by the energy ray, and thus a pressure sensitive adhesive sheet of the second embodiment was obtained.

### Evaluation Method

Each of the pressure sensitive adhesive sheets of the first embodiment and the pressure sensitive adhesive sheets of the second embodiment obtained in examples was evaluated by the methods described below. Note that, in the description below, “pressure sensitive adhesive sheet” simply mentioned means both the pressure sensitive adhesive sheet of the first embodiment and the pressure sensitive adhesive sheet of the second embodiment.

### Measurement of Gel Fraction

The gel fraction of each of the energy ray-crosslinkable pressure sensitive adhesive composition layer in the pressure sensitive adhesive sheet of the first embodiment and the pressure sensitive adhesive layer in the pressure sensitive adhesive sheet of the second embodiment obtained in examples was measured by the method described below.

After the pressure sensitive adhesive sheet obtained in each example was cut into a size of 80 mm length×80 mm width, the easy release film and the tight release film were removed, and only the pressure sensitive adhesive composition layer or the pressure sensitive adhesive layer was retrieved. Hereinafter, the retrieved pressure sensitive adhesive composition layer or pressure sensitive adhesive layer is referred to as “measurement target”.

Next, the measurement target was wrapped in a polyester mesh (mesh size: 200), for which the mass was measured in advance, and a test sample was prepared. The test sample was allowed to stand still in an environment at a temperature of 23° C. and a relative humidity of 50% for 24 hours, and then the mass of the test sample was weighed by a precision balance. Then, the mass of the measurement target alone before immersion was calculated by subtracting the mass of the polyester mesh from the measured value. This measured mass of the measurement target was designated M1.

The test sample was then immersed in toluene at room temperature (23° C.) for 168 hours. After the immersion, the test sample was taken out. The test sample was dried in an oven at 100° C. for 2 hours and then allowed to stand still in an environment at a temperature of 23° C. and a relative humidity of 50% for 24 hours. After the drying, the mass of the test sample was weighed by a precision balance. Then, the mass of the measurement target alone after the immersion and the drying was calculated by subtracting the mass of the polyester mesh from the measured value. This measured mass of the measurement target was designated M2.

Based on the value of the mass M1 of the measurement target before the immersion and the value of the mass M2 of the measurement target after the immersion and the drying, gel fraction was calculated based on the following equation.

Gel fraction (mass %)=(M2/M1)×100

### Measurement of Peel Strength

After the easy release sheet was released from the pressure sensitive adhesive sheet obtained in each of examples, the exposed pressure sensitive adhesive surface was adhered to a polyethylene terephthalate film (thickness: 50 μm) at room temperature (23° C.) using a laminating machine. The obtained sheet was cut into a strip form having a width of 25 mm, and the tight release sheet was released. The exposed pressure sensitive adhesive surface of the pressure sensitive adhesive sheet was pressure-bonded to SUS304, which was an adherend, by allowing a roller having a weight of 2 kg to roll back and forth for once, in accordance with JIS Z 0237:2000. After the pressure bonding, the resulting material was allowed to stand still in an environment at 23° C. and 50% RH (relative humidity) for 24 hours, and the obtained sample was used as a sample for peel strength measurement.

Using the sample for peel strength measurement prepared as described above as a measurement sample, the peel strength was measured at a tensile speed of 300 mm/min by 180° peeling method in an environment at 23° C. and 50% RH (relative humidity) by using a tensile tester (product name “Tensilon (trade name)”, available from A&D Company, Limited) in accordance with JIS Z 0237:2000.

### Evaluation of Holding Power

The holding power of the pressure sensitive adhesive sheet was measured by the following procedure in accordance with JIS Z 0237:2000.

After the easy release sheet was released from the pressure sensitive adhesive sheet obtained in each of examples, the exposed pressure sensitive adhesive surface of the pressure sensitive adhesive sheet was adhered to a polyethylene terephthalate film (thickness: 50 μm) at room temperature (23° C.) using a laminating machine. The obtained sheet was cut into a strip form having a width of 25 mm, and the tight release sheet was released. The exposed pressure sensitive adhesive surface of the pressure sensitive adhesive sheet was pressure-bonded to SUS304, which was an adherend, by allowing a roller having a weight of 2 kg to roll back and forth for five times, in accordance with JIS Z 0237:2000. After the pressure bonding, the resulting material was allowed to stand still in an environment at 23° C. and 50% RH (relative humidity) for 30 minutes, and the obtained sample was used as a sample for holding power measurement.

The sample for holding power measurement prepared as described above was transferred into a thermostat oven at 40° C. or 80° C. A weight was set to the pressure sensitive adhesive sheet in a manner that a constant load of 1 kgf was applied in a perpendicular direction, and the test was performed for up to 70000 seconds. Thus, the holding power of the pressure sensitive adhesive sheet was evaluated. Note that the meaning of representation in the evaluation results of the holding power in Table 1 is as follows. In the following description, “X” means a numerical value.

70000<: Displacement, cohesive failure, and falling of the pressure sensitive adhesive sheet did not occur 70000 seconds after the test started.

X mm displacement: The pressure sensitive adhesive sheet displaced by X mm in a perpendicular direction 70000 seconds after the test started; however, cohesive failure and falling of the pressure sensitive adhesive sheet did not occur.

X sec AT: The pressure sensitive adhesive sheet fell without cohesive failure X seconds after the test started.

X sec cf: Cohesive failure occurred in the pressure sensitive adhesive sheet X seconds after the test started.

TABLE 1

| | Formulation | | | | | | | | |
|---|---|---|---|---|---|---|---|---|---|
| | | Compar- | | | | | | | |
| | Com- | ative | | | | | | | |
| | ponent | com- | | | | | | | |
| | (A) | ponent | | | | | Com- | Com- | |
| | SBS | SIS | | | | | ponent | ponent | |
| | con- | con- | | | | | (C) | (D) | |
| | taining | taining | | | | | Photo | Soft- | |
| | vinyl | no | | | | | poly- | ener | Com- |
| | group | vinyl | | | | | meriz- | that is | ponent |
| | in | group | Component (B) | | | | ation | liquid | (E) |
| | side | in side | Tackifier | | | | initi- | at | Anti- |
| | chain | chain | (B1) | (B2) | (B3) | (B4) | ator | 23° C. | oxidant |
| Example 1 | 100 | | 140 | | | | 3 | 60 | 3 |
| Example 2 | 100 | | 125 | | | | 3 | 75 | 3 |
| Example 3 | 100 | | 110 | | | | 3 | 90 | 3 |
| Example 4 | 100 | | 120 | | | | 3 | 55 | 3 |
| Example 5 | 100 | | 100 | | | | 3 | 50 | 3 |
| Example 6 | 100 | | | 140 | | | 3 | 60 | 3 |
| Example 7 | 100 | | | | 140 | | 3 | 60 | 3 |
| Example 8 | 100 | | | | | 140 | 3 | 60 | 3 |
| Compar- | | 100 | 140 | | | | 3 | 60 | 3 |
| ative | | | | | | | | | |
| Example 1 | | | | | | | | | |

| | Evaluation results | | | | | | | |
|---|---|---|---|---|---|---|---|---|
| | Pressure sensitive adhesive sheet of first | | | | Pressure sensitive adhesive sheet | | | |
| | embodiment | | | | of second embodiment | | | |
| | (before UV irradiation) | | | | (after UV irradiation) | | | |
| | Peel | Gel | Holding | Holding | Peel | Gel | Holding | Holding |
| | strength | fraction | power | power | strength | fraction | power | power |
| | (N/25 mm) | (mass %) | (40° C.) | (80° C.) | (N/25 mm) | (mass %) | (40° C.) | (80° C.) |
| Example 1 | 28.3 | 5.2 | 3.5 mm | 247 sec | 25.5 | 35.6 | 70000< | 70000< |
| | | | displacement | At | | | | |
| Example 2 | 22.1 | 5.7 | 14 mm | 120 sec | 19.3 | 37.1 | 70000< | 70000< |
| | | | displacement | At | | | | |
| Example 3 | 16.0 | 4.5 | 15 mm | 63 sec | 12.7 | 38.8 | 70000< | 70000< |
| | | | displacement | At | | | | |
| Example 4 | 24.5 | 5.6 | 1.2 mm | 207 sec | 22.0 | 41.9 | 70000< | 70000< |
| | | | displacement | At | | | | |
| Example 5 | 22.5 | 5.1 | 0.2 mm | 436 scc | 17.8 | 43.1 | 70000< | 70000< |
| | | | displacement | At | | | | |
| Example 6 | 26.5 | 5.8 | 1.8 mm | 352 sec | 23.8 | 34.6 | 70000< | 70000< |
| | | | displacement | At | | | | |
| Example 7 | 27.0 | 6.7 | 70000< | 31 sec | 22.5 | 34.8 | 70000< | 70000< |
| | | | | At | | | | |
| Example 8 | 25.0 | 7.9 | 4.5 mm | 196 sec | 23.0 | 35.7 | 70000< | 70000< |
| | | | displacement | At | | | | |
| Compar- | 23.0 | 6.6 | 7462 | 20 sec | 22.5 | 7.5 | 5295 sec | 30 sec |
| ative | | | sec cf | cf | | | cf | cf |
| Example 1 | | | | | | | | |

As is clear from Table 1, the pressure sensitive adhesive sheets of the second embodiment obtained in Examples 1 to 8 each caused no displacement, no cohesive failure, and no falling in the holding power test at 80° C. and had high heat resistance while good peel strength was achieved.

On the other hand, in the pressure sensitive adhesive sheet of Comparative Example 1 using the SIS having no vinyl group in a side chain, cohesive failure occurred in the holding power test at 40° C. and 80° C. even after the UV irradiation, and thus the pressure sensitive adhesive sheet had poor heat resistance.

### REFERENCE SIGNS LIST

1 Energy ray-crosslinkable pressure sensitive adhesive composition layer
2, 2a, 2b Release material
3 Pressure sensitive adhesive layer
4 Base material
10a, 20a, 30a Pressure sensitive adhesive sheet of first embodiment
10b, 20b, 30b Pressure sensitive adhesive sheet of second embodiment

1: An energy ray-crosslinkable pressure sensitive adhesive composition comprising:
(A) a block copolymer of an aromatic vinyl compound and a diene compound, the block copolymer containing a vinyl group in a side chain;
(B) a tackifier having a softening point of 80° C. or higher and 150° C. or lower; and
(C) a photopolymerization initiator.

2: The energy ray-crosslinkable pressure sensitive adhesive composition according to claim 1, wherein the vinyl group contained in the side chain of the block copolymer (A) is a 1,2-vinyl group.

3: The energy ray-crosslinkable pressure sensitive adhesive composition according to claim 1, wherein the aromatic vinyl compound is a styrene-based compound.

4: The energy ray-crosslinkable pressure sensitive adhesive composition according to claim 1, wherein the diene compound is 1,3-butadiene.

5: The energy ray-crosslinkable pressure sensitive adhesive composition according to claim 1, wherein the tackifier (B) is a resin containing an aromatic ring.

6: The energy ray-crosslinkable pressure sensitive adhesive composition according to claim 5, wherein the resin containing an aromatic ring is a styrene-based resin.

7: The energy ray-crosslinkable pressure sensitive adhesive composition according to claim 1, wherein the tackifier (B) has a number average molecular weight (Mn) of from 500 to 2000.

8: The energy ray-crosslinkable pressure sensitive adhesive composition according to claim 1, wherein a content of the tackifier (B) is from 50 to 200 parts by mass per 100 parts by mass of the block copolymer (A).

9: The energy ray-crosslinkable pressure sensitive adhesive composition according to claim 1, further comprising:
(D) a softener that is liquid at 23° C.

10: The energy ray-crosslinkable pressure sensitive adhesive composition according to claim 9, wherein a content of the softener (D) is from 10 to 150 parts by mass per 100 parts by mass of the block copolymer (A).

11: An optical material, comprising:
the energy ray-crosslinkable pressure sensitive adhesive composition according to claim 1.

12: A pressure sensitive adhesive sheet, comprising:
an energy ray-crosslinkable pressure sensitive adhesive composition layer containing the energy ray-crosslinkable pressure sensitive adhesive composition according to claim 1 on a base material or a release material.

13: A crosslinked pressure sensitive adhesive obtained by irradiating the energy ray-crosslinkable pressure sensitive adhesive composition according to claim 1 with an energy ray.

14: The crosslinked pressure sensitive adhesive according to claim 13, which has a gel fraction of from 10 to 70 mass %.

15: A method for producing the crosslinked pressure sensitive adhesive according to claim 13, the method comprising:
irradiating the energy ray-crosslinkable pressure sensitive adhesive composition with an energy ray.

16: A pressure sensitive adhesive sheet, comprising:
a pressure sensitive adhesive layer containing the crosslinked pressure sensitive adhesive according to claim 13 on a base material or a release material.

17: A method for producing the pressure sensitive adhesive sheet according to claim 16, the method comprising:
forming an energy ray-crosslinkable pressure sensitive adhesive composition layer containing the energy ray-crosslinkable pressure sensitive adhesive composition on the base material or the release material; and
irradiating the energy ray-crosslinkable pressure sensitive adhesive composition layer with an energy ray.
